(19) United States
(12) Patent Application Publication
(10) Pub. No.: US 2011/0128238 A1
(43) Pub. Date: Jun. 2, 2011

(54) ELECTRIC DEVICE AND CONTROL METHOD THEREOF

(75) Inventors: Jaeseok Han, Seoul (KR); Sukhyun Lim, Seoul (KR); Isu Byun, Seoul (KR); Sang Hyuck Lee, Seoul (KR); Woo Jin Suh, Seoul (KR)

(73) Assignee: LG ELECTRONICS INC.

(21) Appl. No.: 12/750,482

(22) Filed: Mar. 30, 2010

(30) Foreign Application Priority Data
Nov. 27, 2009 (KR) 10-2009-0116166

(51) Int. Cl. G06F 3/041

(52) U.S. Cl. 345/173

(57) ABSTRACT

An electric device and its control method are disclosed. The electric device includes: a display unit; a receiving unit configured to receive paper; a sensing unit configured to detect at least one of a state of the received paper and a state of user's handwriting input to the received paper; and a controller configured to display a result value calculated based on the detection of the sensing unit on the display unit. A state of paper or a state of handwriting input to the paper is detected and a corresponding result value is displayed on the display unit, thus improving emotional quality of the electric device.

This nonprovisional application claims priority under 35 U.S.C. §119(a) on Patent Application No. 10-2009-0116166 filed in Republic of Korea on Nov. 27, 2009 the entire contents of which are hereby incorporated by reference.

### BACKGROUND

1. Field

This document relates to an electric device and its control method and, more particularly, to an electric device capable of detecting a state of paper or a state of handwriting input to the paper and displaying a corresponding result value on a display unit, thereby improving emotional quality of the electric device, and its control method.

2. Related Art

As functions of electric devices such as personal computers, notebook computers, mobile phones, and the like, become diversified, the electric devices are implemented as multimedia players supporting complicated functions such as capturing images or video, reproducing or playing music or video files, playing games, receiving broadcast signals, and the like.

As the usage coverage of the electric devices extends, demand for high-performance electric devices is increasing. In addition, demand for electric devices facilitating users' input is also increasing.

### SUMMARY

An aspect of this document is to provide an electric device capable of detecting a state of paper or a state of a handwriting input to the paper and displaying a corresponding result value on a display unit, thereby improving emotional quality of the electric device, and its control method.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 is a schematic block diagram of an electric device according to an exemplary embodiment of the present invention.

FIG. 2 is a flow chart illustrating an operational process of the electric device of FIG. 1.

FIG. 3 is a perspective view showing two configurations of the electric device of FIG. 1.

FIG. 4 is a drawing illustrating how sheets of paper with various marks or indications are combined to the electric device of FIG. 3.

FIG. 5 is a drawing illustrating the operations of the electric device combined with the sheets of paper with various marks or indications.

FIG. 6 is a drawing illustrating a state in which a user inputs handwriting to paper combined to the electric device of FIG. 4.

FIG. 7 is a drawing illustrating a state in which calendar paper is combined to the electric device of FIG. 4.

FIG. 8 is a drawing illustrating one operation of the electric device according to a state of received paper.

FIG. 9 is a drawing illustrating another operation of the electric device according to a state of received paper.

FIG. 10 is a drawing illustrating still another operation of the electric device according to a state of received paper.

FIG. 11 is a drawing illustrating yet another operation of the electric device according to a state of received paper.

FIG. 12 is a flow chart illustrating an operational process of an electric device according to another exemplary embodiment of the present invention.

FIG. 13 is a drawing illustrating one function of the electric device of FIG. 12.

FIG. 14 is a drawing illustrating another function of the electric device of FIG. 12.

FIG. 15 is a drawing illustrating still another function of the electric device of FIG. 12.

FIG. 16 is a drawing illustrating yet another function of the electric device of FIG. 12.

### DETAILED DESCRIPTION

The present invention will now be described more fully with reference to the accompanying drawings, in which exemplary embodiments of the invention are shown. The invention may, however, be embodied in many different forms and should not be construed as being limited to the embodiments set forth herein; rather, there embodiments are provided so that this disclosure will be thorough and complete, and will fully convey the concept of the invention to those skilled in the art.

Hereinafter, a mobile terminal relating to the present invention will be described below in more detail with reference to the accompanying drawings. In the following description, suffixes “module” and “unit” are given to components of the mobile terminal in consideration of only facilitation of description and do not have meanings or functions discriminated from each other.

The mobile terminal described in the specification can include a cellular phone, a smart phone, a laptop computer, a digital broadcasting terminal, personal digital assistants (PDA), a portable multimedia player (PMP), a navigation system, and so on.

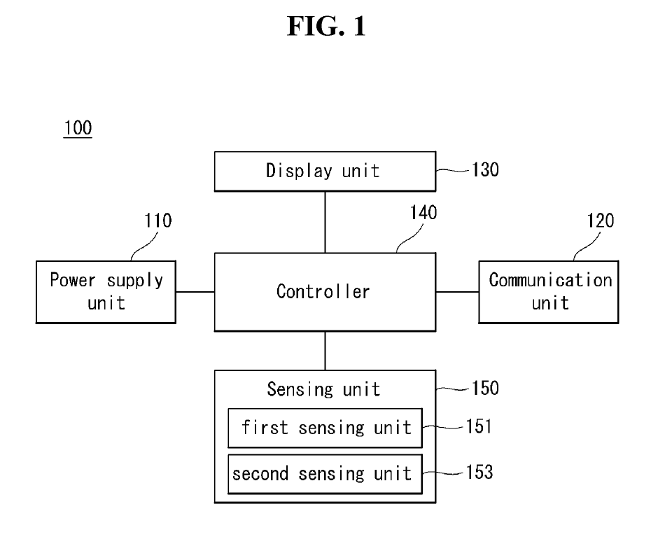

FIG. 1 is a schematic block diagram of an electric device according to an exemplary embodiment of the present invention.

As shown in FIG. 1, an electric device 100 according to an exemplary embodiment of the present invention includes a power supply unit 110, a communication unit 120, a display unit 130, a controller 140, and a sensing unit 150.

The power supply unit supplies power required for operations of each element of the electric device 100. The power source unit 110 may convert power from an external source connected by wireline and supply the same to each element of the electric device 100 or supply power provided from a battery installed in the electric device 100 to each element of the electric device 100. The operation of the power supply unit 110 may be controlled by a control signal from the controller 140.

The communication unit 120 allows for communication via wireline or wirelessly. When the communication unit 120 is configured to allow for radio communication, the communication unit 120 may include one or more modules allowing for radio communication between the electric device 100 and a wireless communication system or between the electric device 100 and a network in which the electric device 100 is located. For example, the communication unit 110 may include a broadcast receiving module, a mobile communication module, a wireless Internet module, a short-range communication module, a location information module, and the like.

The display unit 130 may display information processed in the electric device 100. The display unit 130 may be configured as at least one of a liquid crystal display (LCD), a thin film transistor-LCD (TFT-LCD), an organic light emitting diode (OLED) display, a flexible display, a three-dimensional (3D) display, or the like. Some of them may be configured to be transparent or light-transmissive to allow viewing of the exterior, which may be called transparent displays. A typical transparent display may be, for example, a TOLED (Transparent Organic Light Emitting Diode) display, or the like. A rear side of the display unit 130 may also have such a light-transmissive structure. Through such configuration, a user can view an object situated at the rear side of the electric device 100 through a region occupied by the display unit 130 of the electric device 100. The electric device 100 may include two or more physically discriminated display units 130 according to an implementation form of the electric device 100. The display unit 130 may be provided with a sensor for sensing or detecting a touch operation. In this case, the display unit 130 may function as both an output device and an input device. The touch sensor may have a form of a touch film, a touch sheet, a touch pad, and the like. The touch sensor may be configured to convert pressure applied to a particular portion of the display unit 130 or a change in the capacitance or the like generated at a particular portion of the display unit 130 into an electrical input signal. The touch sensor may be configured to detect the pressure when a touch is applied, as well as the touched position and area. When there is a touch input with respect to the touch sensor, a corresponding signal may be transmitted to a touch controller provided in the touch sensor itself or to the controller 140. Upon receiving the touch signal, the controller 140 may recognize which portion of the display unit 130 has been touched.

The controller 140 typically controls the general operations of the electric device 100. The controller 140 may include a multimedia module for reproducing multimedia data. Also, as described above, in case of the display unit 130 comprising the touch sensor, the controller 140 can recognize the user's touch input.

The sensing unit 150 allows the electric device 100 to receive a particular input from the exterior. The electric device 100 may operate according to a controlling operation of the controller 140 or upon receiving an external signal via the communication unit 120. Also, the sensing unit 150 senses (or detects) a particular input from the user or a change in an external environment to make an operational state of the electric device 100 change. The sensing unit 150 may sense a particular input from the user or a change in an external environment to affect the operation of the electric device 100. The user's particular input and the sensing of the change in the external environment are common in that they are input signals to affect the operation of the electric device 100. In this case, the user's particular input and the sensing of the change in the external environment may be discriminated in that the former corresponds to receiving the movement directly made by the user and the latter corresponds to receiving a signal excluding the direct movement of the user. The sensing unit may be configured as a camera, an ultrasonic detection device, and an input recognition device. The sensing unit 150 will be described in detail later in a relevant case. The sensing unit 150 may be divided into a first sensing unit 151 and a second sensing unit 153.

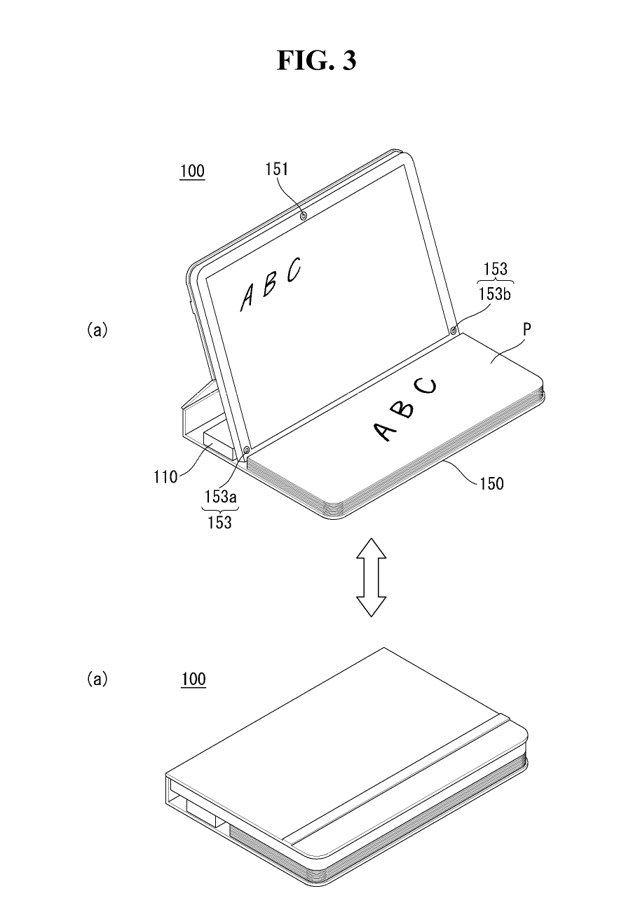

The first sensing unit 151 may detect a state of the paper (P in FIG. 3) received in a receiving unit (160 in FIG. 3) of the electric device 100. The state of the paper may be one of tearing a portion of the received paper (P in FIG. 3), attaching different paper to the received paper (P in FIG. 3), and folding a portion of the received paper (P in FIG. 3). The state of the paper may be handwriting, pictures, symbols, and the like, expressed on the received paper (P in FIG. 3). For example, when the paper (P in FIG. 3) with a handwriting performed thereon is received, the handwriting is recognized by the first sensing unit 151 and the recognized handwriting may be displayed on the display unit 130.

The first sensing unit 151 can detect a current state of the paper itself The first sensing unit 151 detecting the current state of the paper may be configured as a camera. For example, the first sensing unit 151, namely, the camera, may continuously capture images of the state of the received paper (P in FIG. 3) to detect a change. Thus, when the user tears or folds the paper or attach different paper to the received paper, the first sensing unit 151 can detect the corresponding action. A result value detected by the first sensing unit 151 is displayed on the display unit 130 through the controller 140. Namely, the fact that a portion or the entirety of the paper was torn, folded or attached can be reflected to be displayed on the display unit 130.

The second sensing unit 153 can detect a state of handwriting of the user on the received paper. The second sensing unit 153 is different from the first sensing unit 151 that detects an initial state of the received paper and a physical change in the paper, in that it can detect the state of handwriting applied to the paper by the user.

The second sensing unit 153 may be ultrasonic detection devices (153a and 153b in FIG. 3). When the second sensing unit 153 is configured as the ultrasonic wave detection units (153a and 153b in FIG. 3), the ultrasonic wave detection units (153a and 153b in FIG. 3) provided at the body of the electric device 100 can detect ultrasonic waves generated from a writing instrument used by the user. As the ultrasonic wave detection units (153a and 153b in FIG. 3) detect the position of the writing instrument used by the user, what kind of handwriting the user is inputting on the paper (P in FIG. 3) can be known. Meanwhile, when the second sensing unit 153 is configured as a pressure recognition unit, it may be provided at a lower end portion of the paper (P in FIG. 3). Accordingly, when the user writes or draws a picture on the paper (P in FIG. 3) with the writing instrument, the pressure recognition unit can detect a writing pressure. The controller 140 may generate a control signal corresponding to the detected writing pressure to display content of the user's handwriting input.

The first and second sensing units 151 and 153 may be separately provided or may be configured as a single body. For example, when the first and second sensing units 151 and 153 are implemented as a camera, the camera can play the roles of both the first and second sensing units 151 and 153. Also, the first and second sensing units may be configured as cameras, respectively. Namely, in this case, the state of handwriting input, as well as the state of the received paper (P in FIG. 3), can be detected by the cameras. As described above, the first and second sensing unit 151 and 153 can be variably configured, but, hereinafter, a case where the first and second sensing units 151 and 153 are configured as a camera and a ultrasonic wave detection unit, respectively, will be described for the sake of brevity, as such description is also similarly applicable to other cases.

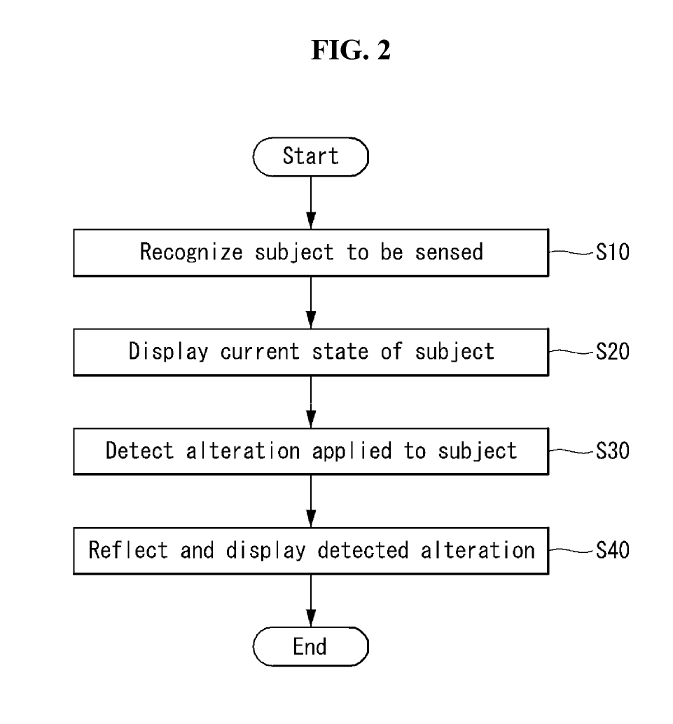

FIG. 2 is a flow chart illustrating an operational process of the electric device of FIG. 1.

As shown in FIG. 2, the electric device 100 according to an exemplary embodiment of the present invention may include recognizing a sensing subject (i.e., a subject to be sensed) (S10).

The sensing subject may be the paper (P in FIG. 3) received in the electric device 100. The electric device may include the receiving unit (160 in FIG. 3) for receiving the paper (P in FIG. 3), the sensing subject. The sensing unit 150 provided in the electric device 100 may recognize whether or not the paper (P in FIG. 3) has been received by the receiving unit (160 in FIG. 3). When the sensing unit 150 recognizes that the paper (P in FIG. 3) has been received by the receiving unit (160 in FIG. 3), the electric device 100 enters a state in which a current state of the received paper (P in FIG. 3) and an alteration of the received paper is detected.

When the sensing subject is recognized, the current state of the sensing subject is displayed (S20).

The current state of the sensing subject may include a state in which a portion or the entirety of the paper (P in FIG. 3), i.e., the sensing subject, is torn off, a folded state of the paper (P in FIG. 3), and written words or pictures expressed on the paper (P in FIG. 3).

When the current state of the sensing subject is detected, the detected current state of the sensing subject may be displayed on the display unit 130. For example, when a portion of the received paper (P in FIG. 3) is folded, the folded state of the paper may be displayed on the display unit 130. In this case, the folded state itself of the paper (P in FIG. 3) may be displayed on the display unit 130 or the function of the electric device 100 related to folding of the paper (P in FIG. 3) may be executed.

Detecting an alteration applied to the sensing subject by the user (S30), and reflecting and displaying the detected alteration (S40) may be performed

The alteration applied to the sensing subject may include user's action of tearing a portion or the entirety of the paper (P in FIG. 3), the sensing subject, folding a portion of the paper, or performing handwriting or drawing a picture. When the user applies alteration to the sensing subject, corresponding content may be displayed on the display unit 130 in real time. Meanwhile, the detected alteration may be displayed as it is on the display unit 130 or may be displayed in association with a particular function of the electric device 100. For example, when the user performs handwriting on the paper (P in FIG. 3), a sensing signal is inputted from the sensing unit 150 to the controller 140 and the controller 140 drives a word processor to display content of the handwriting from the user.

FIG. 3 is a perspective view showing two configurations of the electric device of FIG. 1.

As shown in FIG. 3, the electric device 100 according to an exemplary embodiment of the present invention may have an open configuration (a) and a closed configuration (b).

The open configuration (a) refers to a state in which the user uses the electric device 100. In the open configuration (a), the user may perform handwriting input or the like on the paper (P) received in the receiving unit 160. The display unit 130 may include the camera, the first sensor 151, and the ultrasonic wave detection unit, the second sensor 153. The power supply unit 110 may be installed at a rear end of the display unit 130.

The closed configuration (b) refers to a state in which the user carries around the electric device 100. In the closed configuration (b), the display unit 130 is rotated centering around a hinge (not shown) so as to be brought into contact with the paper (P).

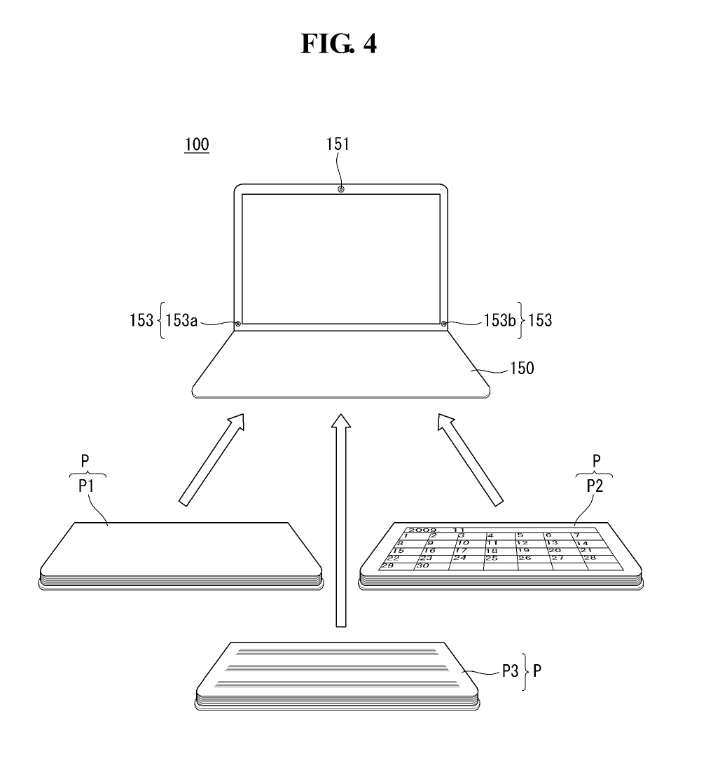

FIG. 4 is a drawing illustrating how sheets of paper with various marks or indications are combined to the electric device of FIG. 3.

As shown in FIG. 4, the receiving device 1500 of the electric device according to an exemplary embodiment of the present invention may receive various types of paper (P).

The receiving unit 160 includes a clip (not shown) to fix the received paper (P). The receiving unit 160 may include a receiving sensor (not shown). The receiving sensor (not shown) may detect whether or not the paper (P) has been received, apart from the sensing unit (150 in FIG. 1). Also, the receiving sensor (not shown) may detect an identifier according to the type of the paper (P) and execute the function of the electric device 100 according to the detected type of the paper (P). The identifier may be a hole formed at one side of the paper (P). The number or position of holes, identifiers, may vary depending on the type of paper (P) according to a predetermined rule. For example, when the paper (P) is blank paper (P1), one hole may be provided as an identifier. When the paper (P) is a calendar (P2), two holes may be provided as an identifier. The receiving sensor (not shown) may determine the type of the received paper (P) upon detecting the number of holes.

Various types of paper (P1 to P3) may be combined on the receiving unit 160. For example, the blank paper (P1), the paper (P2) with the calendar expressed thereon, and manuscript paper (P3) may be combined on the receiving unit 160.

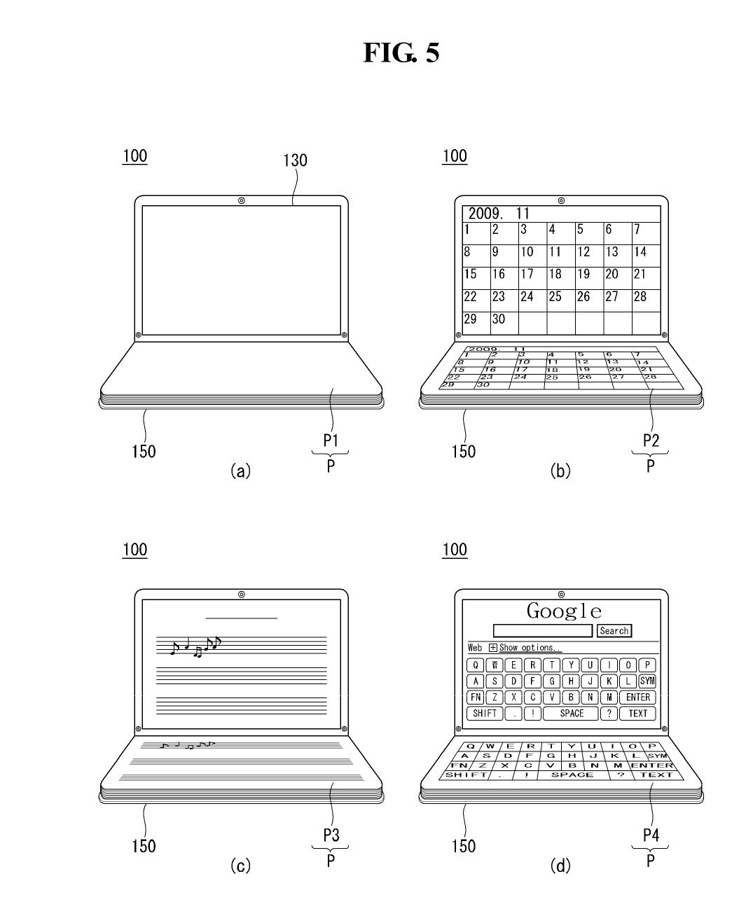

FIG. 5 is a drawing illustrating the operations of the electric device combined with the sheets of paper with various marks or indications.

As illustrated, in the electric device 100 according to an exemplary embodiment of the present invention, an image displayed on the display unit 130 may change according to the type of the paper (P) received on the receiving unit 160.

As shown in FIG. 5(a), when the paper (P) received on the receiving unit 160 is the blank paper (P1), a blank image may be displayed on the display unit 130. Meanwhile, when the user replaces the paper (P) received on the receiving unit 160 with the calendar (P2), the calendar (P2) may be displayed on the display unit 130 as shown in FIG. 5(b). When the user replaces the paper (P) received on the receiving unit 130 with the manuscript paper (P3), a corresponding image of the manuscript paper (P3) may be displayed on the display unit 130 as shown in FIG. 5(c). When the user replaces the paper (P) received on the receiving unit 160 with a Qwerty keyboard (P4), an image of the Qwerty keyboard (P4) may be displayed on the display unit 130. as shown in FIG. 5(d). Namely, the screen image of the electric device according to an exemplary embodiment of the present invention may change such that it corresponds to the paper (P) replaced by the user.

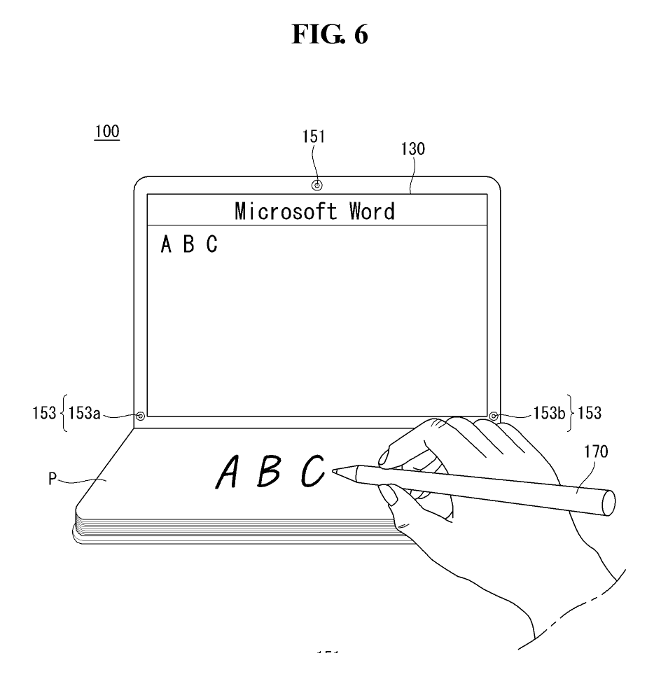

FIG. 6 is a drawing illustrating a state in which a user inputs handwriting on paper combined to the electric device of FIG. 4.

As shown in FIG. 6, the electric device according to an exemplary embodiment of the present invention allows the user to input handwriting on the Paper (P) by using a writing instrument 170.

When the user inputs handwriting on the paper (P) by using the writing instrument 170, corresponding content may be displayed on the display unit 130. This will be described in detail as follows.

When the user writes a character on the paper (P) with the writing instrument 170, ultrasonic waves may be generated from an ultrasonic wave generating unit installed at the end of the writing instrument 170. The ultrasonic wave generated from the ultrasonic wave generating unit may be received by the second sensing unit 153 which may be configured as an ultrasonic wave detection unit. The controller (140 in FIG. 1) may recognize at which position of the paper (P) the user is moving the writing instrument 170 by calculating time of the ultrasonic wave received by the first and second sensing unit 153a and 153b. Namely, the controller (140 in FIG. 1) can recognize an absolute position with respect to the corresponding position on the paper (P). In displaying the handwriting of the user on the display unit 130, the controller (140 in FIG. 1) may map the calculated absolute position such that it corresponds to the screen of the display unit 130 or may display the calculated absolute position as it is on the screen of the display unit 130. In the former case, even if the user slightly moves the writing instrument, its corresponding movement may appear to be bigger on the display unit 130 or the opposite.

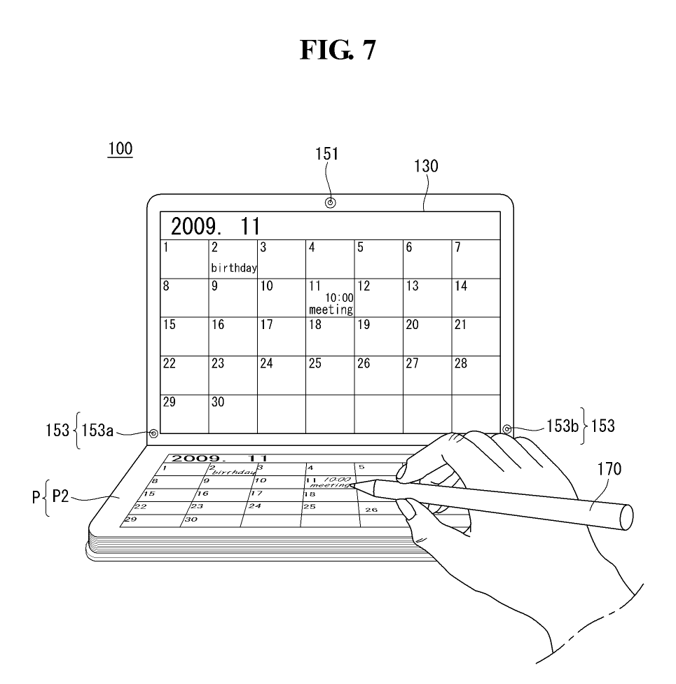

FIG. 7 is a drawing illustrating a state in which calendar paper is combined to the electric device of FIG. 4.

As shown in FIG. 7, when the paper (P) received on the receiving unit 160 is the calendar (P2), the display unit 130 of the electric device 100 may display a corresponding image.

When the user combines the calendar (P2) on the receiving unit 160, the first sensing unit may detect that the type of the paper (P) is the calendar (P2). As the calendar (P2) is detected, the controller (140 in FIG. 1) may change an image displayed on the display unit 130 such that it corresponds to the detected calendar.

In the state that the calendar (P2) is combined on the receiving unit 160, when the user performs a handwriting input on the calendar (P2) with the writing instrument 170, corresponding content may be displayed on the display unit 130.

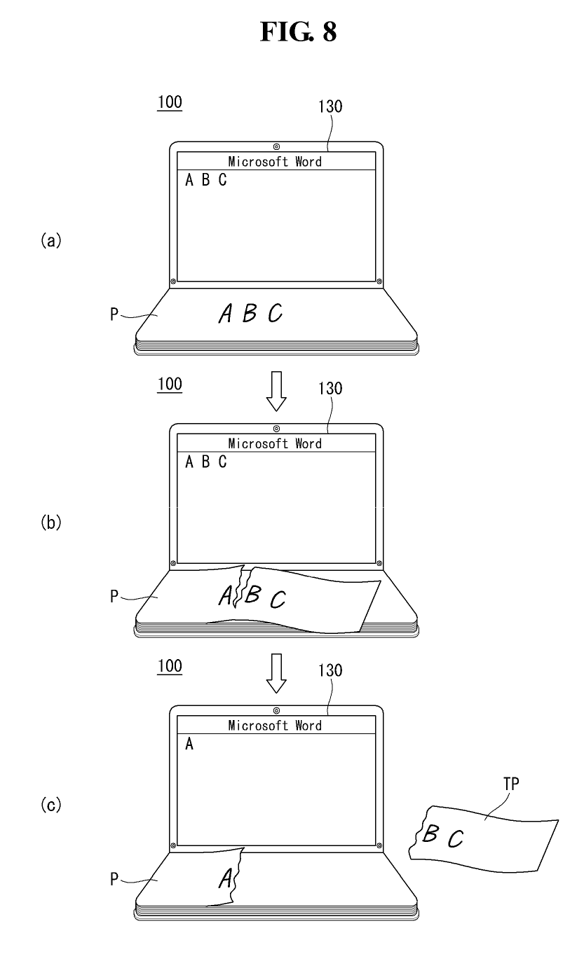

FIG. 8 is a drawing illustrating one operation of the electric device according to a state of received paper.

As illustrated, the electric device 100 according to an exemplary embodiment of the present invention can intuitively delete content which has been inputted.

As shown in FIG. 8(a), the user may write letters desired to be inputted on the paper (P).

As shown in FIG. 8(b), the user may tear off a portion of the paper (P). In the electric device 100. Tearing a portion or the entirety of the paper (P) may mean deletion of content written on the paper (P). Namely, it means that the content written on the torn-off paper (TP) may be deleted and the content written on the remaining paper (P) may be stored in the electric device 100. In general, when content created on the paper (P) is not necessary, the corresponding portion of the paper (P) is torn off. According to an exemplary embodiment of the present invention, the electric device 100 associates such user's action with deletion of the content written on the electric device 100, whereby the user can intuitively use the electric device 100.

As shown in FIG. 8(c), written content on the remaining paper (P), not the torn-off portion of the paper, may be displayed on the display unit 130.

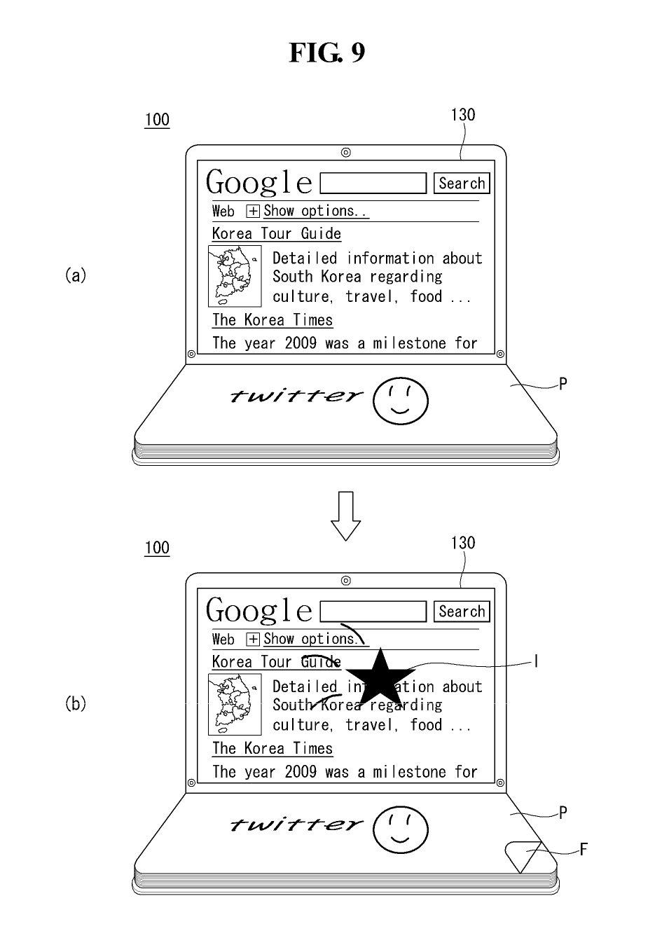

FIG. 9 is a drawing illustrating another operation of the electric device according to a state of the received paper.

As illustrated, in the electric device 100 according to an exemplary embodiment of the present invention, when a portion of the paper (P) is folded, content displayed on the screen may be added to the favorite.

As shown in FIG. 9(a), the user may perform web surfing by using the electric device 100. In this case, the user may want to add a current Web page to the favorite.

As shown in FIG. 9(b), the user may fold a corner (F) portion of the paper (P). It may be previously set such that the user's action of folding the corner (F) of the paper (P) indicates adding of a Web page displayed on the screen to the favorite. Accordingly, the controller (140 in FIG. 1) may display an indicator (I) indicating that the operation of adding the Web page to the favorite has been performed, on the display unit 130 and store the corresponding fact in a memory.

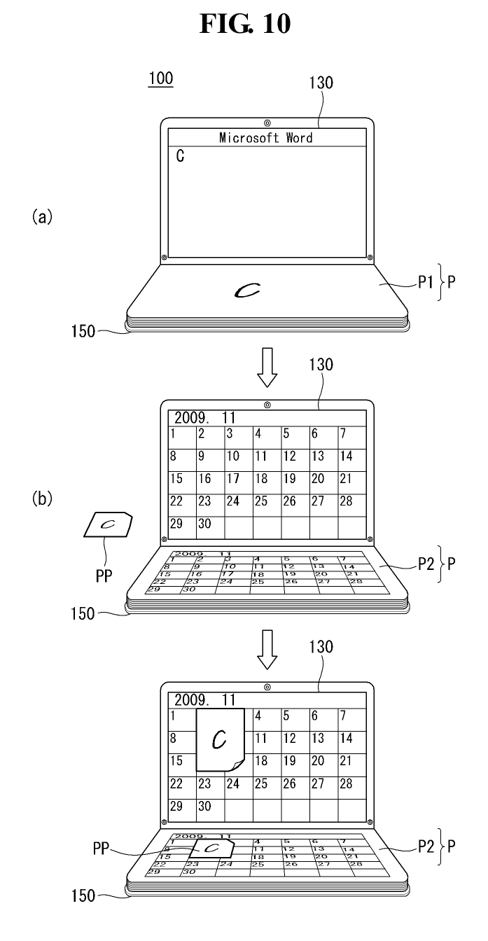

FIG. 10 is a drawing illustrating still another operation of the electric device according to a state of received paper.

As illustrated, in the electric device 100 according to an exemplary embodiment of the present invention, content displayed on the display unit 130 may change depending on the type of the payer (P) received on the receiving unit 160, and content described on a different paper (PP) may be written in the electric device 100 by attaching the different paper (PP).

As shown in FIG. 10(a), the user may perform a desired handwriting input by using the paper (P), i.e., the blank paper (P1).

As shown in FIGS. 10(b) and 10(c), the user may replace the paper (P), i.e., the blank paper (P1), with the paper (P), i.e., the calendar (P2). After the user receives the paper (P), i.e., the calendar (P2), on the receiving unit 160, the user may perform a desired handwriting. Also, the user may attach the different paper (PP) to the calendar (P2). When the user attaches the different paper (PP) to the calendar (P2), content written on the different paper (PP) may be displayed on the display unit 130. In addition, when the content of the different paper (PP) is displayed, it may be also recorded in the memory of the electric device 100. In FIG. 10, the different paper (PP) is attached to the paper (P), i.e., the calendar (P2), but the present invention is not limited thereto. Namely, the different paper (PP) can be attached to any other paper than the paper (P) as the calendar (P2).

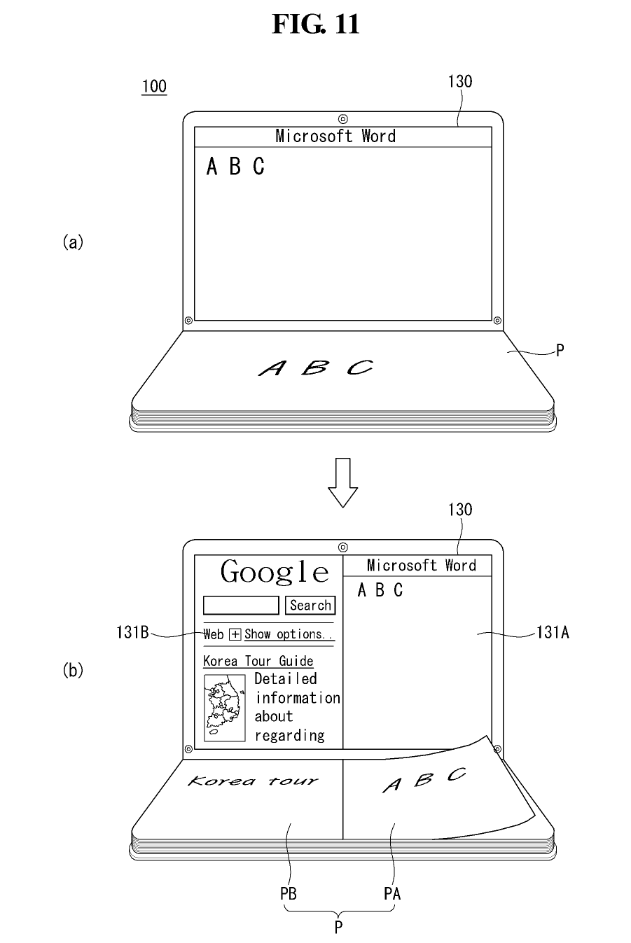

FIG. 11 is a drawing illustrating yet another operation of the electric device according to a state of received paper.

As illustrated, in the electric device 100 according to an exemplary embodiment of the present invention, when the user folds the paper (P), the display unit 130 may be divided according to the user's action.

As shown in FIG. 11(a), the user may perform a desired handwriting input on the paper (P), and the user's handwriting input can be reflected to be displayed on the display unit 130.

As shown in FIG. 11(b), the user may fold the paper (P) and then unfolds it. When the user folds and soon unfolds the paper (P), the controller (140 in FIG. 1) may divide a screen image displayed on the display unit 130. Namely, one screen image may be divided into a plurality of screen images. This means that, for example, when the paper (P) is divided into first and second paper parts (PA and PB) based on the folded center of the paper (P), the display unit 130 is divided into first and second display parts 131A and 131B.

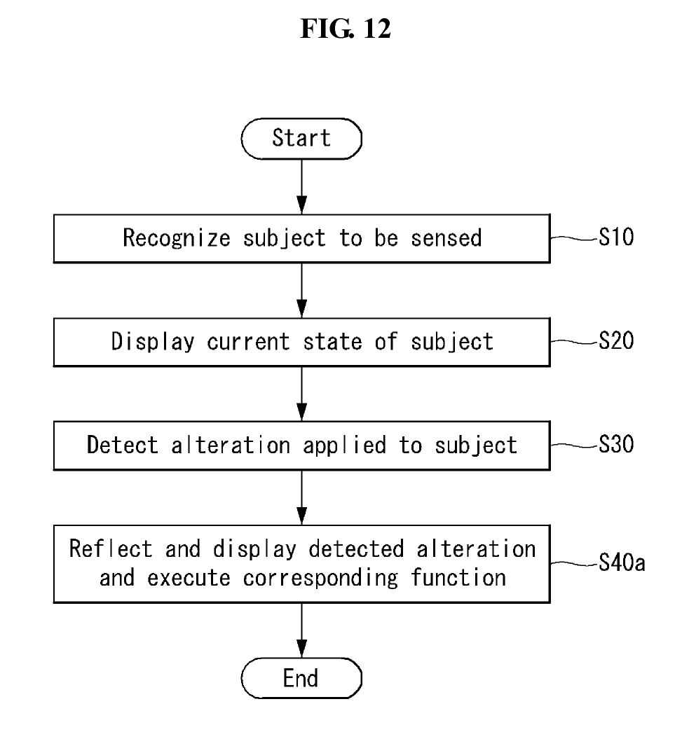

FIG. 12 is a flow chart illustrating an operational process of an electric device according to another exemplary embodiment of the present invention.

As illustrated, the electric device 100 according another exemplary embodiment of the present invention may execute a function corresponding to a user input.

The electric device 100 according another exemplary embodiment of the present invention may be discriminated from the electric device 100 according one exemplary embodiment of the present invention, in that it performs step S40a of reflecting and displaying a detected alteration and executing a corresponding function. Steps S10 to S30 are the same as those of the electric device 100 according to one exemplary embodiment of the present invention, so its detailed description will be omitted.

The detected alteration may be the result of a user's action which has been applied to the paper (P) of the electric device 100. For example, when a pre-set particular mark is made on the paper (P), a corresponding particular function is executed. Hereinafter, the particular function will now be described in detail with reference to its relevant drawings.

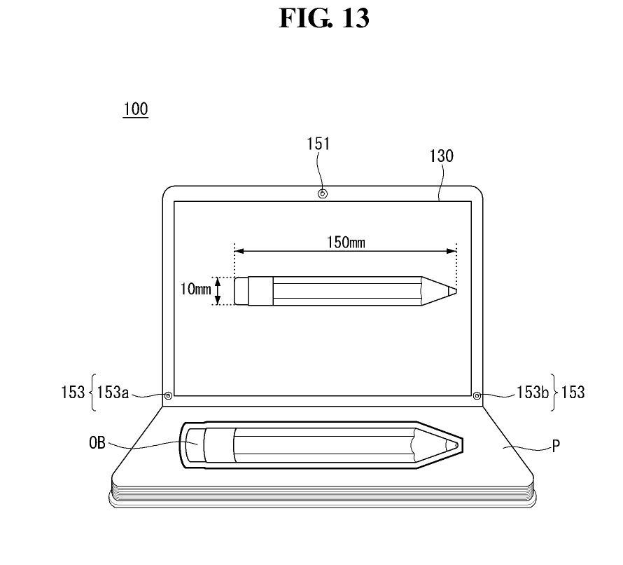

FIG. 13 is a drawing illustrating one function of the electric device of FIG. 12.

As illustrated, in the electric device 100 according another exemplary embodiment of the present invention, when an object (OB) is put on the paper (P), a function of displaying information related to the object (OB) may be executed. For example, when a pencil as an object (OB) is put on the paper (P), the first sensing unit 151 may sense the object (OB) and recognize its size or the like. The display unit 130 may display the size of the recognized object (OB). In addition, the display unit 130 may display a type of the recognized object (OB), information regarding a manufacturer of the recognized object (OB), price information of the recognized object (OB), and the like. Various information of the recognized object (OB) may be acquired via the communication unit 120.

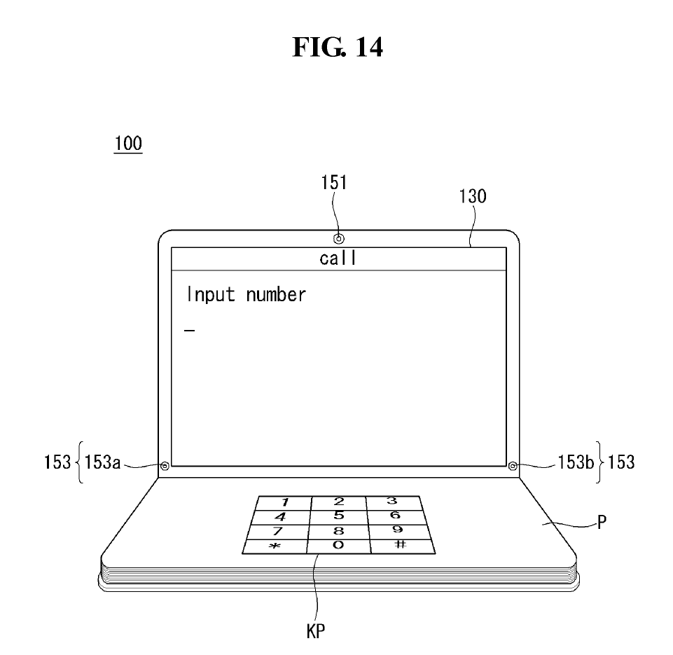

FIG. 14 is a drawing illustrating another function of the electric device of FIG. 12.

As illustrated, the electric device 100 according to another exemplary embodiment of the present invention may execute a call function when a keypad (KP) is drawn on the paper (P). Namely, this means that when the user draws the keypad (KP) on the paper (P), the electric device executes the call function.

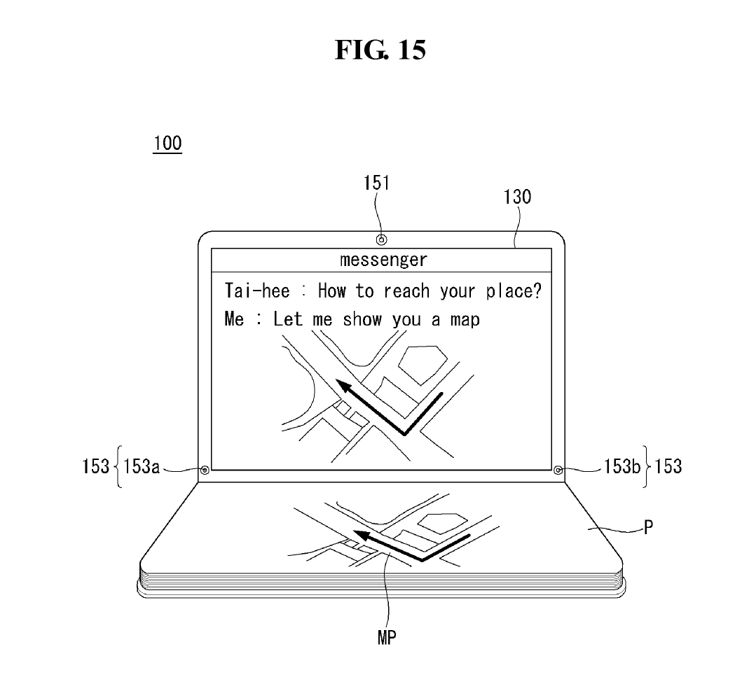

FIG. 15 is a drawing illustrating still another function of the electric device of FIG. 12.

As illustrated, the electric device 100 according to another exemplary embodiment of the present invention may transmit content inputted to the paper (P) through handwriting to another party. Namely, when the user draws a map (MP) on the paper (P) while communicating with another party, the second sensing unit 153 may detect it and transmit the map (MP) drawn by the user to another party.

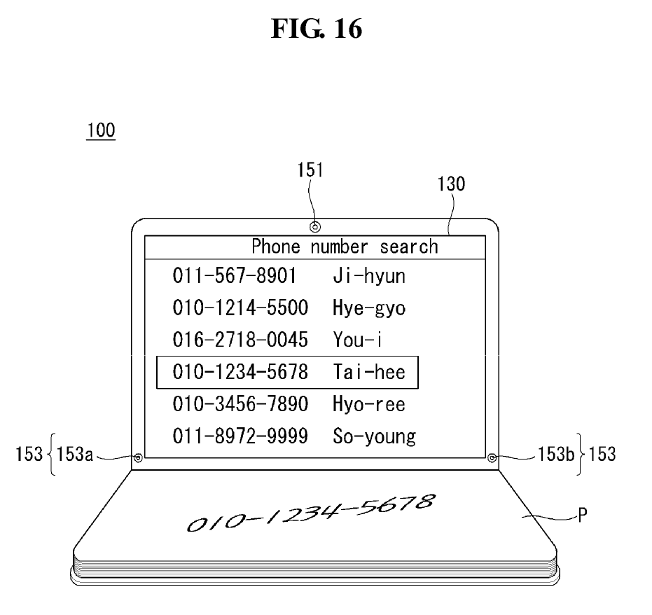

FIG. 16 is a drawing illustrating yet another function of the electric device of FIG. 12.

As illustrated, the electric device 100 according to another exemplary embodiment of the present invention may execute a search function with respect to information inputted by the user through handwriting.

The user may input content desired to be searched to the paper (P) through handwriting. In FIG. 16, when the user inputs content desired to be searched through handwriting, the electric device 100 may search an external server, accessed via the memory or the communication unit 120 of the electric device 100, for the content.

In the above-described exemplary embodiments, the camera and the ultrasonic wave detection units are used as the sensing units, but the present invention is not meant to be limited to those types of sensing units.

The above-described method of controlling the mobile terminal may be written as computer programs and may be implemented in digital microprocessors that execute the programs using a computer readable recording medium. The method of controlling the mobile terminal may be executed through software. The software may include code segments that perform required tasks. Programs or code segments may also be stored in a processor readable medium or may be transmitted according to a computer data signal combined with a carrier through a transmission medium or communication network.

The computer readable recording medium may be any data storage device that can store data that can be thereafter read by a computer system. Examples of the computer readable recording medium may include read-only memory (ROM), random-access memory (RAM), CD-ROMs, DVD±ROM, DVD-RAM, magnetic tapes, floppy disks, and optical data storage devices. The computer readable recording medium may also be distributed over network coupled computer systems so that the computer readable code is stored and executed in a distribution fashion.

A mobile terminal may include a first touch screen configured to display a first object, a second touch screen configured to display a second object, and a controller configured to receive a first touch input applied to the first object and to link the first object to a function corresponding to the second object when receiving a second touch input applied to the second object while the first touch input is maintained.

A method may be provided of controlling a mobile terminal that includes displaying a first object on the first touch screen, displaying a second object on the second touch screen, receiving a first touch input applied to the first object, and linking the first object to a function corresponding to the second object when a second touch input applied to the second object is received while the first touch input is maintained.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electric device comprising:
a display unit;
a receiving unit configured to receive paper;
a sensing unit configured to detect at least one of a state of the received paper and a state of user's handwriting input to the received paper; and
a controller configured to display a result value calculated based on the detection of the sensing unit on the display unit.

2. The device of claim 1, wherein the sensing unit comprises a first sensing unit configured to detect the state of the received paper and a second sensing unit configured to detect the state of the user's handwriting input to the received paper.

3. The device of claim 2, wherein the first and second sensing units are configured as at least one of a camera, an ultrasonic wave detection unit, and a pressure recognition unit.

4. The device of claim 1, wherein the state of the received paper is at least one of a state in which at least a portion of the received paper is torn, an attached state of different paper to the received paper, and a folded state of at least a portion of the received paper.

5. The device of claim 1, wherein the state of the received paper is previously indicated on the received paper and the indication is visually recognized by the user.

6. The device of claim 4, wherein the result value may be at least one of the cutoff state, the attached state, and the folded state.

7. The device of claim 1, wherein the controller executes a function corresponding to the result value calculated based on the detection by the sensing unit.

8. An electric device comprising:
a display unit;
a sensor configured to detect a visual alteration of a subject; and
a controller configured to display a result value reflecting a current state of the subject detected by the sensor on the display unit.

9. The device of claim 8, wherein the visual alteration is a user's handwriting input to the subject.

10. The device of claim 8, wherein the visual alteration is at least one of tearing a portion of the subject, attaching a different subject to the subject, and folding at least a portion of the subject.

11. The device of claim 8, wherein the subject is paper.

12. The device of claim 8, wherein the sensor detects a replacement of the subject and a current state of the replaced subject, and the controller displays the current state of the replaced subject on the display unit.

13. An electric device comprising:
a display unit;
a sensing unit configured to detect at least one of a state of a sensing subject and a user's handwriting input to the sensing subject; and
a controller configured to display a result value calculated based on an output from the sensing unit on the display unit.

14. An electric device comprising:
a display unit;
a sensing unit configured to receive a user's handwriting input to received paper; and
a controller configured to reflect and display the received user's handwriting input on the display unit.

15. The device of claim 14, wherein the sensing unit is at least one of a camera, an ultrasonic wave detection unit, and a pressure recognition unit.

16. An electric device comprising:
a display unit;
a sensing unit configured to detect a state of received paper; and
a controller configured to reflect and display the state of the received paper on the display unit.

17. The device of claim 16, wherein the state of the received paper is at least one of a state in which at least a portion of the received paper is torn, an attached state of different paper to the received paper, and a folded state of at least a portion of the received paper.

18. A method for controlling an electric device, the method comprising:
recognizing a sensing subject;
displaying a current state of the recognized sensing subject on a display;
detecting an alteration applied to the recognized subject by a user; and
displaying the detected alteration on the display unit.

19. The method of claim 18, wherein the sensing subject is paper.

20. The method of claim 18, wherein the alteration applied to the recognized sensing subject by the user is at least one of tearing at least a portion of the sensing subject, attaching different paper to the sensing subject, and folding at least a portion of the sensing subject.

21. The method of claim 18, wherein the alteration applied to the recognized sensing subject by the user is a user's handwriting input to the sensing subject.
